(19) United States
(12) Patent Application Publication
(10) Pub. No.: US 2004/0004309 A1
(43) Pub. Date: Jan. 8, 2004

(54) Adaptable personal care product formulation method

(76) Inventor: Lesley L. Sears, Fort Wayne, IN (US)

Correspondence Address: Todd T. Taylor, TAYLOR & AUST, P.C., 142 S. Main St., P.O. Box 560, Avilla, IN, 46710, US

(21) Appl. No.: 10/601,817

(22) Filed: Jun. 23, 2003

Related U.S. Application Data
(60) Provisional application No. 60/390,430, filed on Jun. 24, 2002.

(51) Int. Cl. B29C 43/00

(52) U.S. Cl. 264/325; 264/40.1

(57) ABSTRACT

An adaptable personal care product formulation method including the steps of obtaining a personal profile including at least one of hair type, skin type, lifestyle, skin ailments, hair condition and ethnicity, soliciting personal preferences including at least one of color and texture, and formulating a personal care product based on the personal profile and personal preferences.

### CROSS REFERENCE TO RELATED APPLICATIONS

This is a non-provisional patent application based upon U.S. provisional patent application serial No. 60/390,430 “PROCESS, METHOD, SYSTEM AND APPARATUS FOR PROVIDING PERSONAL CUSTOMIZED SKIN CARE, COLOR COSMETICS, HAIR CARE, NAIL CARE AND FRAGRANCE PRODUCTS”, filed Jun. 24, 2002.

### BACKGROUND OF THE INVENTION

1. Field of the Invention

The present invention relates to a personal care product, and, more particularly, to a method for preparing a formulation for a personal care product.

2. Description of the Related Art

Cosmetics include preparations that are externally applied to change or enhance the beauty of the skin, hair, nails, lips and eyes. The use of body paint for ornamental and religious purposes has been common among primitive peoples from prehistoric times. Ointments, balms, powders and hair dyes have also been used from ancient times. Many cosmetics originated in Asia, where the ingredients and uses are first recorded in Egyptian Tombs, wherein cosmetic jars called kohl pots and applicators have been found. Egyptians use kohl to darken their eyes and the paint was often used on the face. Additionally, fingers were often dyed with henna. Greek women used charcoal pencils and rouge sticks of alkanet and coated their faces with powder, which often contained dangerous lead compounds. Beauty aids reach a peak in Imperial Rome, where chalk for the face and a rouge called fucus was utilized. Many cosmetics survived the middle ages and the Crusaders brought back rare Eastern oils and perfumes. In the Renaissance, cosmetics, usually white lead powder and vermilion, were used extravagantly. From the seventeenth century, recipes and books on the production of cosmetics abounded. Professional cosmologists began to appear who often prescribed baths of wine or milk. Cosmetics were at their height in 1760, and then the use of cosmetics virtually disappeared with the advent of the French Revolution. In the year 1900 there was a revival of their use, accompanied by the manufacture of beauty aids on a scientific basis in France. Since then the industry has grown by tremendous proportions with cosmetic products being manufactured for every conceivable use. In the United States cosmetics that are intended for interstate commerce are controlled under the Federal Food, Drug and Cosmetic Act of 1938.

A person that desires to purchase cosmetics is confronted with a time consuming and often unsatisfactory result. Due to the wide variety of personal needs, a retailer is confronted with the need to minimize inventory and maximize profit. Therefore, retail outlets often carry only a limited number of product lines by various manufactures. If the customer cannot locate a particular product that meets their need, they are required to visit additional retail outlets and often only a compromise product is obtained. The customer can utilize catalogs to broaden the selections on a cost effective basis. However, colors and textures of materials cannot always be adequately represented on an imprinted media.

One attempt to meet the need is in the form of cosmetic consultants that may meet with a customer in the home to suggest the use of certain products. However, this method is also limited relative to the number of colors, textures, oil contents and concentrations, thereby limiting the customer's ability to obtain a truly satisfactory product.

What is needed in the art is a cost effective customized personal care product formulation method.

### SUMMARY OF THE INVENTION

The present invention provides, a method of producing a customized personal care product relying on the customer's experience with a product and/or anticipated changes with the customer's lifestyle.

The invention comprises, in one form thereof, an adaptable personal care product formulation method including the steps of obtaining a personal profile including at least one of hair type, skin type, lifestyle, skin ailments, hair condition and ethnicity, soliciting personal preferences including at least one of color and texture, and formulating a personal care product based on the personal profile and personal preferences.

An advantage of the present invention is that a person's personal experience with a personal care product and anticipated changes in the person's life style and/or environment are accounted for in the formulation of a new cosmetic product.

Another advantage is that current experience with a product is utilized to formulate a new personal care product.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a schematized view of an embodiment of a kiosk retail deliver system for a personal care product of the present invention; and

FIG. 2 is a block diagram of an embodiment of a method of the present invention utilized in the kiosk of FIG. 1.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

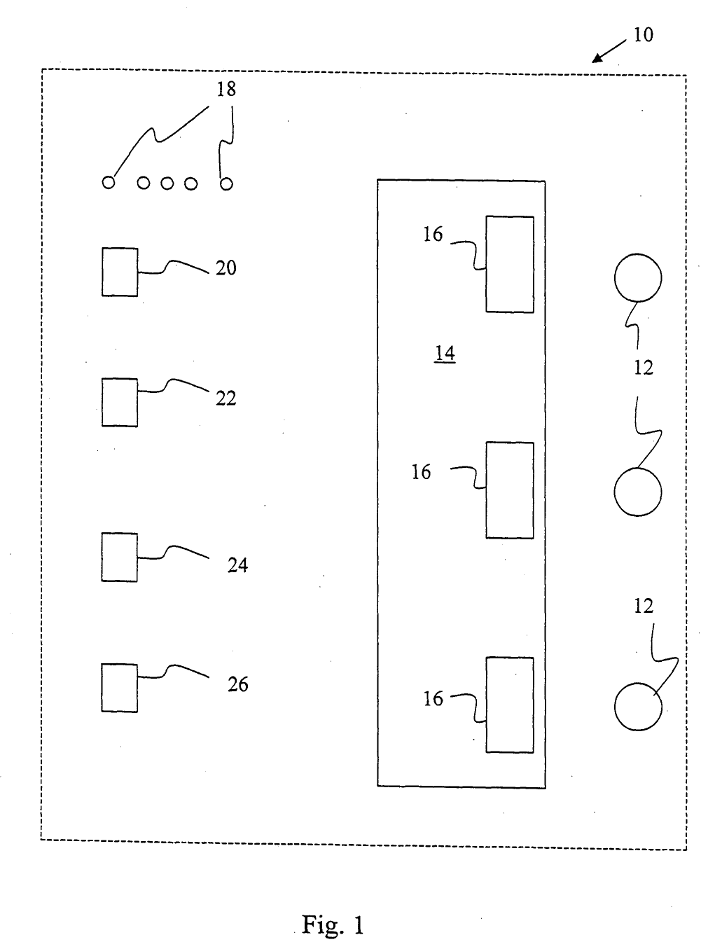

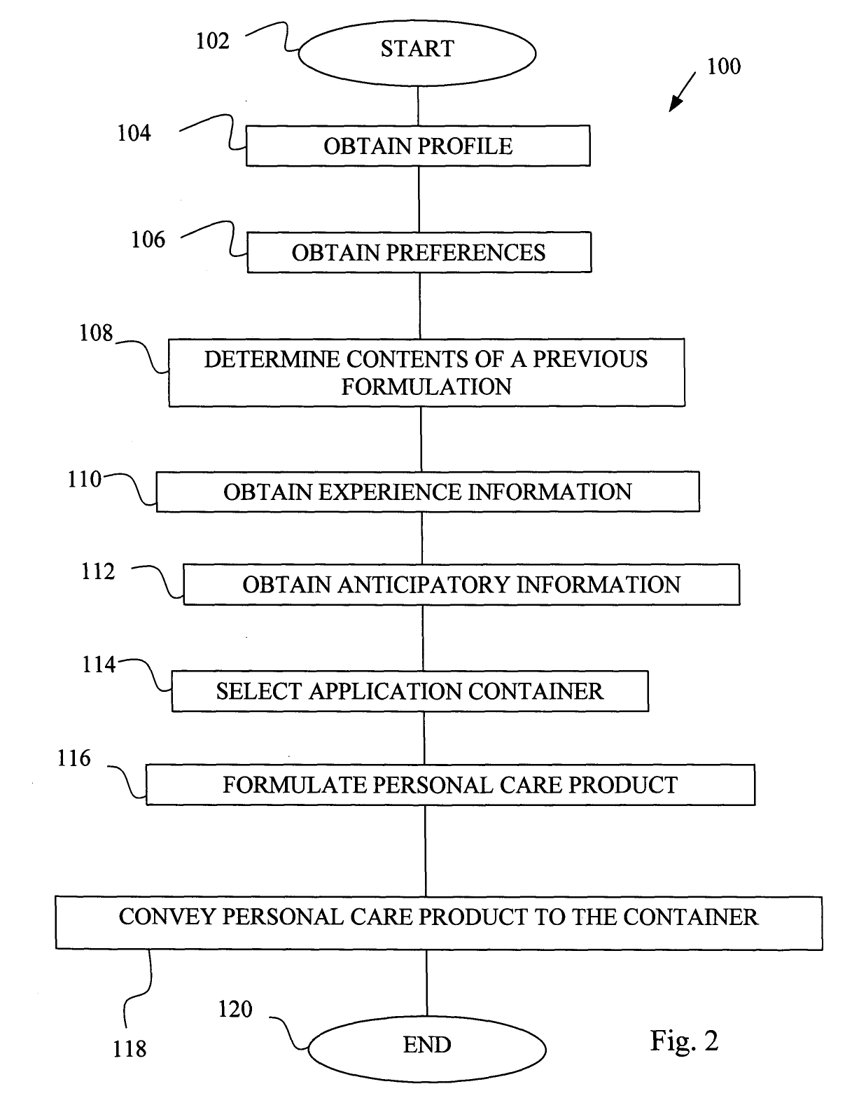

Referring now to the drawings, and more particularly to FIGS. 1 and 2, there is shown one embodiment of kiosk delivery system 10 of the present invention. Kiosk delivery system 10 includes customer seating 12, a work surface 14, product stations 16, precalibrated dispenser systems 18, a blending device 20, a heating apparatus 22, a molding device 24 and a container loading apparatus 26. A customer sits on customer seating 12 and interacts with the a system operator who suggests and interfaces with the customer to obtain information relative to the particular production station 16 care product. Product station 16 may include product samples or simulations, either in printed or in a displayed format on a computerized screen.

Precalibrated dispenser systems 18 include precalibrated pumps either under the control of a computer or manually operated; premeasured spoons; scales, other dispensing mechanisms such as tablets, capsules and prepackaged quantities of particular ingredients. Predetermined quantities of items from dispenser system 18 are incorporated into a container in a prescribed method for subsequent blending, molding and/or containerizing. Additionally, the product may undergo a heating process to elevate the temperate of the product to a point in which elements may be liquefied or to enhance blending. Blending element 20 and heating element 22 may be combined to advantageously allow blending and heating of the product at the same time.

Once a product is properly blended, if it is to be utilized in a solid or semi-solid manner, the product is then molded into an application form in mold 24. Mold 24, also known as a cosmetic press, produces elongated quasi-cylindrical applicators for use as lipstick or other coloring applications. Additionally, mold device 24 may form shaped compressions of the product for use in a compact, eye shadow or eyelash product.

Container loading apparatus 26 is utilized to place a measured amount of the blended product into one or more application containers. Application containers consist of a variety of shapes and application nozzles to enhance the application of the customized product.

Formulation method 100 starts at step 102, which corresponds to the customer appearing at kiosk 10 to initiate method 100, wherein the customer interacts with the trained kiosk operator. Although steps 104-114 are illustrated in a sequential manner, it is understood that the trained operator may utilize only some of the steps and perform them in an alternate order from that shown in FIG. 2.

At step 104, the trained kiosk operator obtains personal profile information from the customer. Personal profile information may include hair type, skin type, lifestyle, skin ailments, hair condition, ethnicity and age. Some of the personal profile information may additionally include such things as customer opinions relative to their skin condition, current hair treatment and known or perceived allergies.

At step 106, personal preferences are obtained, which include such things as hair color, eye shadows, rouges, highlights, colors, fragrances, flavors and product textures. This information may be input into a computer, placed on a paper form or the memory of the trained kiosk operator may be utilized to evaluate the information provided in the steps of this method.

At step 108, the trained kiosk operator determines the contents of a previous formulation of a product utilized by the customer. The determination may be made by a chemical analyzer, the ingredients printed on the cosmetic or if the customer is a previous customer, the formulation previously provided to the customer by way of either a computer data record or from the list of ingredients on the previously produced personal care product or by way of a coded reference thereon.

At step 110, information regarding the customer's experience with the previous formulation is obtained. This step is closely related to step 108 in that the contents of the previous formulation are evaluated to correlate to the experience indicated by the customer in step 110. The information regarding the current experience with a previous formulation provides information to the trained kiosk operator to be able to modify and enhance desirable features of the prior formulation or to minimize undesirable experiences with the previous formulation.

At step 112, the trained kiosk operator obtains anticipatory change information from the customer. This anticipatory information may include the travel plans of the customer, which would indicate an exposure to different environmental factors such as exposure to weather, temperature, humidity, chemical and particulate matter in the atmosphere, as well as anticipated durations of exposure to the aforementioned factors. Other anticipated changes relate to such things as an individual's pregnancy status, age, changes in the environment, changes in medication such as chemotherapy. Additionally, changes in smoking habits, concentrations of hormonal supplements, internally taken vitamins and changes in diet. The anticipatory information is utilized in method 100 to provide a personal care product that prepares the customer's body for the anticipated change.

At step 114, the customer selects a particular application container. The application container includes an application device through which the customized personal care product is applied to the skin, hair, eyelid, eyelash, etc. The size of the container is utilized by method 100 to determine the quantities of elements to put into the formulation. Additionally, the application container may be selected for its color, texture and/or ergonomic features based upon a customer's preferences along with input from the trained kiosk operator.

At step 116, the personal care product is formulated, mixed and/or molded based on at least one of the prior steps in method 100. Ideally the input from the customer, including the profile and preference information is combined with experience with a former product and anticipated changes in the customer's lifestyle and environment to arrive at the precise formulation for the customer. The selected product formulation, based upon the aforementioned steps and arrived at from information, is used to determine the prescribed quantities of elements to be used from dispenser system 18. The formulation may also be contained in written materials or in the training of the kiosk operator. Additionally, a small sample of the formulation may be prepared for the customer to try while at customer seating 12.

At step 118, the formulated personal care product is conveyed to a container by container loading apparatus 26. In this step it is anticipated that normally one container will be utilized, however, multiple containers or even multiple different containers may be utilized to contain the personal care product. For example, the product may be formulated to fill one applicator container and another container that can be subsequently used to refill the applicator container.

Product station 16 includes a base product station, a toner/water station, a specialty station, an oil/vitamin station, a color station, and a lip station. The base product station includes such products as a cleanser base, a toner base, a moisture base and/or a carrier oil base. The toner/water station includes toners, which serve to modify the pH of the formulation. The toners include waters such as rose water, lavender water and chamomile water. The specialty station includes such products as various clays, finishing veil, exfoliants, mascara base, various flavorings and/or fragrances. The oil/vitamin station includes various vitamins, essential oils and proteins. The color station includes products having various pigments, iron oxides, premixed foundation colors, titanium dioxide and various colored micas. The lip station includes such products as a variety of premixed lip base colors, premixed frosts, clear lip base and gloss.

Specifically, base product ingredients include creme cleanser base, clear cleanser base, toner base, creme moisture base, moisture base, vitamin serum base and carrier oil base. Vitamins include vitamin A, vitamin E, vitamin C, vitamin K and vitamin B. Minerals include iron oxides, zinc oxides and titanium dioxides. Carrier oils include sweet almond oil, avocado oil, grape seed oil and jojoba oil. Essential oils include ginger root oil, lavender oil, neroli oil, patchouli oil, tea tree oil and ylang ylang oil. Specialty active ingredients include aloe, glycolic acid, salicylic acid, alpha hydroxyl acid, benzyl peroxide, dimethicone, cocoa butter, dihyroxyacetone, white clay, red clay and dead sea clay. Flower waters include chamomile water, cornflower water, lavender water, orange blossom water, rose water, rosemary water and witch hazel water. Exfoliants include sea salt, crushed apricot kernels and vitamin A.

In order to enhance the operation of kiosk 10 and method 100, formulation cards may be provided to the trained kiosk operators that indicate particular enhancements that result from the mixing of particular ingredients as well as those mixtures that should be avoided. Formulation cards are keyed to correspond to answers obtained from inquiries used to carry out steps 102-114. The resulting customized personal care product is then labeled, meeting any and all labeling requirements, and may additionally include a formulation number and/or code to allow the trained kiosk operator to easily duplicate a product for a return customer.

The method and system described above allows a customer to custom order a variety of skin care, color cosmetics, hair care, nail care and fragrances. Since the final products are actually blended on the spot, they can be customized to meet the customer's needs and desires, including color, texture, vitamins, essential oils, specialty actives, fragrance, flavor and frost. The method of the present invention offers the opportunity for the customer to interact with a professional to determine important aspects of skin care, color cosmetics, hair care, nail care and fragrances for their individual use. This takes into consideration such things as skin care, lifestyle, age, skin ailments, ethnicity and personal preferences. The customer information is managed in a computer database, which is interconnected by a way of a network system such as the Internet to thereby allow kiosk 10 operations to exist in various places so that the customer can simply go to a kiosk, of the present invention, that is convenient for the customer and get the same uniform product or alteration of their current personal care product.

For example, if a multi-vitamin enriched cleanser is desired, a creme cleanser base has enhancements of vitamin A and vitamin C added thereto, along with any desired fragrance, resulting in the multi-vitamin enriched cleanser desired by the customer. If the customer has indicated that she has a skin condition and the trained kiosk operator has determined that condition would be enhanced by additional vitamin A, then the method allows for an additional unit of vitamin A to be added to the multi-vitamin enriched cleanser, thereby enhancing the desired property.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. An adaptable personal care product formulation method, comprising the steps of:
obtaining personal profile elements including at least one of hair type, skin type, lifestyle, skin ailments, hair condition and ethnicity;
soliciting personal preferences including at least one of color and texture; and
formulating a personal care product dependant upon each of said personal profile elements and said personal preferences.

2. The method of claim 1, wherein said personal profile elements is skin type.

3. The method of claim 1, further comprising the step of compressing said personal care product, thereby forming it into an elongated shape.

4. The method of claim 3, wherein said compressing step is carried out with a manual cosmetic press.

5. The method of claim 1, further comprising the step of containerizing said personal care product in an application container.

6. The method of claim 1, wherein said formulating step includes the step of blending at least one active ingredient and at least one base ingredient.

7. The method of claim 6, wherein said at least one active ingredient includes vitamins, minerals, carrier oils, essential oils, pigments, specialty chemicals, exfoliants, flavorings and fragrances.

8. An adaptable cosmetic formulation method, comprising the steps of:
securing the contents of a present cosmetic;
obtaining information relative to personal experience with said present cosmetic; and
formulating a new cosmetic based on said contents and said personal experience.

9. The method of claim 8, wherein said information includes background information including at least one of hair type, skin type, lifestyle, skin ailments, hair condition and ethnicity.

10. The method of claim 8, further comprising the steps of compressing said cosmetic into an elongated shape.

11. The method of claim 10, wherein said compressing step is carried out with a manual cosmetic press.

12. The method of claim 8, wherein said formulating step includes the step of blending at least one active ingredient and at least one base ingredient.

13. The method of claim 12, wherein said at least one active ingredient includes vitamins, minerals, carrier oils, essential oils, pigments, specialty chemicals, exfoliants, flavorings and fragrances.

14. A method of adapting a personal care product formulation, comprising the steps of:
obtaining anticipatory information, said anticipatory information being changes that a person expects their body to encounter;
additionally obtaining current experience information relative to the personal care product; and
formulating a new personal care product based on said current experience information and said anticipatory information.

15. The method of claim 14, wherein said anticipatory information includes at least one of pregnancy, age, changes in environment, changes in chemotherapy, changes in a smoking habit, hormonal levels and medications.

16. The method of claim 14, wherein said current experience information includes background information including at least one of hair type, skin type, lifestyle, skin ailments, hair condition and ethnicity.

17. The method of claim 14, further comprising the steps of compressing said personal care product into an elongated shape.

18. The method of claim 17, wherein said compressing step is carried out with a manual cosmetic press.

19. The method of claim 14, wherein said formulating step includes the step of blending at least one active ingredient and at least one base ingredient.

20. The method of claim 19, wherein said at least one active ingredient includes vitamins, minerals, carrier oils, essential oils, pigments, specialty chemicals, exfoliants, flavorings and fragrances.
